(19) United States
(12) Patent Application Publication
(10) Pub. No.: US 2022/0167147 A1
(43) Pub. Date: May 26, 2022

(54) USER EQUIPMENT AND SUBSCRIBER IDENTITY MODULE (SIM) INTERWORKING FOR INTELLIGENTLY OPTIMIZING USER EXPERIENCE

(71) Applicant: T-Mobile USA, Inc., Bellevue, WA (US)

(72) Inventors: Yasmin Karimli, Kirkland, WA (US); Gunjan Nimbavikar, Sammamish, WA (US)

(21) Appl. No.: 16/953,655

(22) Filed: Nov. 20, 2020

(51) Int. Cl. H04W 8/22; H04M 1/725; H04W 4/50

(52) U.S. Cl. CPC H04W 8/22; H04W 4/50; H04M 1/72525

(57) ABSTRACT

User equipment and subscriber identity module (SIM) interworking to optimize user experience is described. In an example, device data associated with a user equipment and SIM data associated with a SIM of the user equipment can be accessed. In an example, the device data and the SIM data can be compared and, based at least in part on the comparing, a notification can be generated. The notification can include an instruction to affect a modification to the user equipment or the SIM (e.g., replace the user equipment, replace the SIM, download software and/or a software update, etc.) to optimize performance of the user equipment, and thus a user experience of a user associated with the user equipment. The notification can be presented via a display of the user equipment.

### BACKGROUND

A subscriber identity module (SIM) is a component of a user equipment (UE) that can store data, such as a unique serial number (ICCID), an international mobile subscriber identity (IMSI) number, security authentication data, contact data, capability data, service data, and/or the like. In some examples, a SIM can be an integrated circuit (e.g., a “SIM card”) that can be inserted and removed from a UE. In some examples, a SIM can be an embedded-SIM (eSIM), which can be a programmable SIM that is embedded directly into a UE. In some examples, SIMs are evolving to include new features and capabilities, and user equipment is evolving to include new features and capabilities, but at inconsistent rates. As a result, some SIMs are incompatible with certain user equipment and vice versa. This can result in poor or sub-optimal user equipment performance and/or user experience.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment associated with techniques described herein.

FIG. 2 illustrates an example process for generating a notification based at least in part on an identified mismatch in device data and subscriber identity module (SIM) data, as described herein.

FIG. 3 illustrates another example process for generating a notification based at least in part on an identified mismatch in device data and SIM data, as described herein.

FIG. 4 illustrates an example graphical user interface in which a notification can be presented.

FIG. 5 illustrates an example graphical user interface in which a notification can be presented.

### DETAILED DESCRIPTION

Techniques described herein are directed to the interworking of a user equipment (UE) and a subscriber identity module (SIM) to intelligently optimize user experience. In an example, an interface can compare device data of a UE with SIM data of a SIM of the UE to determine whether there is a mismatch between the device data and the SIM data that affects user experience. Based at least in part on detecting a mismatch, the interface can generate a notification to update, upgrade, replace, and/or otherwise affect a modification to the user device, a component of the user device, and/or the SIM to redress the mismatch and improve user experience. In some examples, such a comparison can be done using machine learning and/or artificial intelligence. That is, in at least one example, the interface can leverage machine learning and/or artificial intelligence to “intelligently” identify mismatches and/or generate notifications to redress the identify mismatches. In some examples, the interface can be associated with a component on the user equipment, in which the notification can be generated and presented as a system notification. In some examples, the interface can be associated with a component on server(s) associated with a service provider, in which the notification can be generated and sent to the user equipment as a server-notification.

As described above, in some examples, SIMs are evolving, and user equipment is evolving, but at inconsistent rates. As a result, some SIMs can be incompatible with certain user equipment and vice versa. As an example, SIMs can be associated with certain features that can be utilized by some user equipment (e.g., user equipment technically compatible with such SIM features) but may not be available to other user equipment (e.g., user equipment not technically compatible with such SIM features). As an additional or alternative example, user equipment can be configured with features that are conditionally available based on having a particular SIM associated therewith. As such, due to the inconsistent rate at which SIMs and user equipment are evolving, users can suffer from poor, or less than optimal, user experiences if their SIMs and user equipment are not technically compatible.

Techniques described herein can be useful for optimizing user experience by ensuring that user equipment and SIMs are technically compatible. For example, when a service provider introduces a new radio access technology (e.g., Fifth Generation (5G)), some user equipment and/or some SIMs may not be configured to use the new radio access technology. Accordingly, a user using a user equipment configured to use the new radio access technology that is associated with a SIM that is not configured to use the new radio access technology may not be able to access the new radio access technology and/or can have a poor user experience in attempting to use the new radio access technology. As such, techniques described herein can identify the mismatch and can recommend to update, upgrade, replace, and/or otherwise affect a modification to the SIM so that the SIM is capable of using the new radio access technology, thereby improving performance of the user equipment and the user experience for the user.

In some examples, a SIM can be configured to use the new radio access technology, but a user equipment may not be so configured. As such, a user using such a user equipment may not be able to access the new radio access technology and/or can have a poor user experience in attempting to use the new radio access technology. In at least one example, techniques described herein can identify the mismatch and can recommend to update, upgrade, replace, and/or otherwise affect a modification to the user equipment so that it is capable of using the new radio access technology, thereby improving performance of the user equipment and the user experience for the user. That is, techniques described herein can offer improvements to existing technical systems by utilizing an interface that can identify when user equipment and SIMs are technically incompatible and generating notifications for improving such technical compatibility. Not only do such techniques improve performance of the user equipment, such techniques also improve user experiences for users.

Techniques described herein can be further used to optimize user experience, for example, across different brands within a service provider, across different service providers, across different classifications of user equipment (e.g., Internet of Things (IoT), autonomous vehicles, etc.), across different applications and/or services (e.g., healthcare, finance, streaming, etc.), and/or the like. That is, by comparing device data and SIM data, techniques described herein can identify opportunities for improving performance of user equipment and, therefore, improving user experiences associated therewith.

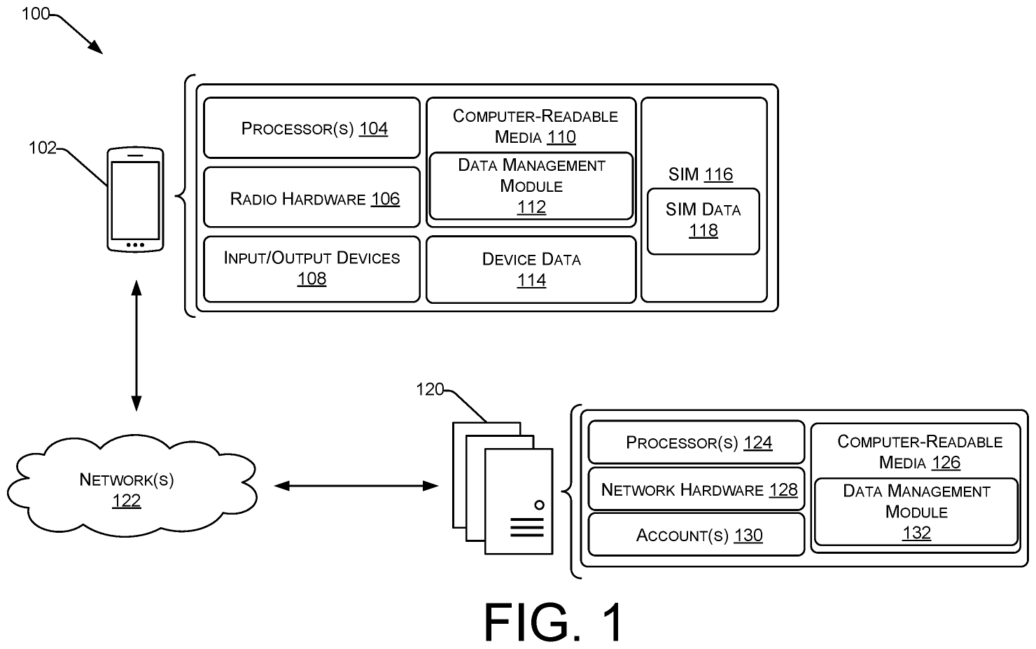

Additional details are described below with reference to FIGS. 1-5.

FIG. 1 illustrates an example environment 100 associated with techniques described herein. In an example, the environment 100 can include a user equipment 102. In at least one example, the user equipment 102 can be configured with processor(s) 104, radio hardware 106, input/output devices 108, and computer-readable media 110.

In at least one example, the user equipment 102 can be any suitable type of computing device configured to communicate over a wired or wireless network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), an IoT device, an in-vehicle (e.g., in-car) computer, a television (smart television), set-top-box (STB), desktop computer, an autonomous vehicle, a medical device, and/or the like. In some examples, the user equipment 102 can be associated with a classification indicating a type of the user equipment 102 (e.g., a mobile phone, an IoT device, an autonomous vehicle, a medical device, etc.).

The processor(s) 104 can represent, for example, a central processing unit (CPU)-type processing unit, a graphics processing unit (GPU)-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc. In at least one example, an accelerator can represent a hybrid device, such as one from ZYLEX or ALTERA that includes a CPU course embedded in an FPGA fabric. In various embodiments, the processor(s) 104 can execute one or more modules and/or processes to cause the user equipment 102 to perform a variety of functionalities, as set forth above and explained in further detail in the following disclosure. Additionally, each of the processor(s) 104 can possess its own local memory, which also can store program modules, program data, and/or one or more operating systems.

The radio hardware 106 provides the user equipment 102 with wireless capabilities, such as connecting to one or more base stations associated with one or more service providers. The radio hardware 106 can include or be incorporated into processors, ASICs, programmable circuits such as FPGAs, or in other ways. In at least one example, the radio hardware 106 can include radios associated with one or more radio access technologies (e.g., second generation (2G), third generation (3G), fourth generation (4G), fifth generation (5G), etc.). The user equipment 102 can include additional or alternative hardware to enable the device to access service provider(s) via additional or alternative network(s) (e.g., BLUETOOTH®, WI-FI®, etc.).

The radio hardware 106 can configure the user equipment 102 for transmitting and/or receiving data wirelessly using any suitable wireless communications and/or data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Service provider (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over internet protocol (VoIP), VoLTE, Institute of Electrical and Electronics Engineers' (IEEE) 802.1x protocols, WiMAX, Wi-Fi, Data Over Cable Service Interface Specification (DOCSIS), digital subscriber line (DSL), and/or any future intern& protocol (IP)-based service provider technology or evolution of an existing IP-based service provider technology.

In at least one example, the user equipment 102 can be associated with radio hardware 106 available by either or any service providers with which the user equipment 102 is configured to be operable with.

The user equipment 102 can include input/output device(s) 108. In at least one example, the input/output device(s) 108 can include a display, which can output information in a pictorial (or, in some examples, tactile) form. The display can be an electroluminescent display, liquid crystal display, a light-emitting diode display, plasma display, quantum dot display, etc. In some examples, the display can be a touch display, whereby touch of the display is an input method. In at least one example, the input/output device(s) 108 can include a speaker, a microphone, a stylus, a mouse, a keyboard, or the like. For the purpose of this discussion, a user can interact with the user equipment 102 via the input/output device(s) 108. That is, a user can provide touch input, speech input, etc. to interact with the user equipment 102. Similarly, the user equipment 102 can output information to the user via presentation on a display, audible output, etc.

Depending on the exact configuration and type of the user equipment 102, the computer-readable media 110, can include computer storage media and/or communication media.

Computer storage media can include volatile memory, nonvolatile memory, and/or other persistent and/or auxiliary computer storage media, removable and non-removable computer storage media implemented in any method or technology for storage of data such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile discs (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, service provider attached storage, storage area service providers, hosted computer storage or any other storage memory, storage device, and/or storage medium that can be used to store and maintain data for access by a computing device.

In at least one example, the computer storage media can include non-transitory computer-readable media. Non-transitory computer-readable media can include volatile and nonvolatile, removable and non-removable tangible, physical media implemented in technology for storage of data, such as computer readable instructions, data structures, program modules, or other data. The computer-readable media 110 is an example of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which can be used to store the desired data and which can be accessed by the user equipment 102. Any such non-transitory computer-readable media can be part of the user equipment 102.

In contrast, communication media includes computer readable instructions, data structures, program modules, or other data in a modulated data signal, such as a carrier wave, or other transmission mechanism. As defined herein, computer storage media does not include communication media.

The computer-readable media 110 can include one or more modules and data structures including, for example, a data management module 112. The one or more modules and data structures can be in the form of stand-alone applications, productivity applications, an operating system component, or any other application or software module to configure the user equipment 102 to perform operations, as described herein. In at least one example, the data management module 112 can compare device data 114 with data associated with a SIM 116 of the user equipment 102 (e.g., SIM data 118) and/or generate notifications for redressing identified mismatches. In some examples, the data management module 112 can utilize machine learning and/or artificial intelligence in comparing the device data 114 and the SIM data 118 and/or generating notifications as described herein. That is, in some examples, the data management module 112 can utilize machine learning model(s) and/or artificial intelligence model(s) (e.g., supervised learning model(s), unsupervised learning model(s), semi-supervised learning model(s), and/or the like) to analyze the device data 114 and the SIM data 118 to identify mismatches and/or generate notifications as described herein. Use of such machine learning and/or artificial intelligence can enable the “intelligent” optimization of user experience, as described herein. Additional details are provided below.

While the data management module 112 is shown as being associated with the computer-readable media 110, in some examples, the data management module 112 can be associated with the SIM 116 instead of, or in addition to, the computer-readable media 110. Location of the data management module 112 can depend on the resource consumption of the data management module 112 and resource availability of the SIM 116. That is, in some examples, the SIM 116 can have fewer resources available than the computer-readable media 110 and, if the data management module 112 requires more resources than are available on the SIM 116, the data management module 112 can be associated with the computer-readable media 110. In some examples, the data management module 112 can be distributed between the computer-readable media 110 and the SIM 116.

In at least one example, device data 114 can be stored on the user equipment 102, for example in a database or other data store. The device data 114 can include, but is not limited to, identification data (e.g., device identifier, etc.), user account data (e.g., name, account number, etc.), service provider data (e.g., current service provider, available service providers, service(s) available via the service provider, etc.), brand data (e.g., current brand associated with the user equipment 102, etc.), context data (e.g., which application(s) are executing on the user equipment 102), capability data (e.g., which radio access technology(s) the user equipment 102 is configured to use, etc.), authentication data, and/or the like. In some examples, the device data 114 can indicate device features, including, but not limited to, radio technology (e.g., NR, LTE, UMTS, CDMA, GSM), a frequency band, voice protocol (e.g., voice on UMTS, CDMA, GSM, etc.), messaging (e.g., SMS), a speed feature (e.g., carrier aggregation (CA), 4×4 multiple input and multiple output (MIMO), or 256QAM modulation in downlink, etc.), regulatory data (e.g., E911 location, wireless emergency alerts (WEA), etc.), dual SIM lock data, dual device unlock data, IP multimedia subsystem (IMS) services (e.g., voice over LTE (VoLTE), wi-fi calling (WFC), rich communication services (RCS), etc.), mobile hotspot data, accessibility data (e.g., text telephone (TTY), real time text (RTT), etc.), a service provider service (e.g., visual voicemail, account management, name/identification, etc.), a third-party application, a setting (e.g., access point name (APN), browser default, ringtone, splash screen, etc.), a background (e.g., identification applications, analytics applications, etc.), etc.

In at least one example, the user equipment 102 can be associated with a SIM 116. In at least one example, the SIM 116 can configure the user equipment 102 to operate via a service provider. That is, the SIM 116 can configure the user equipment 102 such that the user equipment 102 can communicate with other user devices via base stations and/or network devices associated with the service provider. Base stations (also known as cell sites or cell towers) can be associated with antennae and other electronic communications equipment (e.g., transceivers, digital signal processors, control electronics, a GPS receiver, etc.) to create a cell. A service provider can have multiple base stations, creating multiple cells, thereby generating a cellular network. In at least one example, the SIM 116 can enable the user equipment 102 to access services provided via a core network associated with the service provider. In at least one example, such services can include IMS-based services, including but not limited to, telephony services, emergency services (e.g., E911), gaming services, instant messaging services, presence services, video conferencing services, social networking and sharing services, location-based services, push-to-talk services, and so on.

In some examples, the SIM 116 can be a SIM card or an eSIM (e.g., an embedded, electronic, and/or enhanced SIM). A SIM card can be a portable memory chip or an integrated memory chip. Generally, when a user opens an account associated with a service provider, the service provider can activate a SIM card, which can be associated with a user equipment associated with the account of the user. That is, each SIM card includes a unique number printed on the memory chip which requires activation by the service provider (e.g., via a website associated with the service provider, via a call to the service provider, via provisioning by the service provider, etc.). Following activation of an account by the service provider, the user, via the user equipment 102, can utilize various services offered by the service provider.

In some examples, for instance with an eSIM, a profile (e.g., an eSIM profile) including a unique number (i.e., associated with a service provider) and other data (e.g., account data (e.g., subscription key, identity and/or service plan profiles, etc.), restrictions, etc.) can be downloaded by the user equipment 102, and no further activation is required to activate an account associated with the service provider and/or otherwise use services available from the service provider. For instance, a local profile assistant (e.g., computer-readable instructions) associated with the user equipment 102 can download a profile from a service provider and install the profile on the user equipment 102. As a result, the SIM 116 of the user equipment 102, which can be an eSIM, can be associated with the downloaded profile provided by the service provider. General profile provisioning is defined in GSMA RSP (Remote SIM Provisioning) for consumer devices technical specification standard SGP.22, for example.

In some examples, the SIM 116 can store SIM data 118. The SIM data 118 can include personal data of a user, such as, but not limited to, data associated with a phone number of a user associated with the user equipment 102, an address book of the user, text messages sent and received via the user equipment 102, and other data. In at least one example, the SIM data 118 can be associated with profile(s) that can be stored on the SIM 116 or can otherwise be accessible by the SIM 116. In at least one example, a profile can indicate which service plans, services, functionalities, etc. are available for the user equipment 102 from a particular service provider. In some examples, the SIM data 118 can include service provider data (e.g., current service provider associated with the SIM 116, etc.), brand data (e.g., current brand associated with the SIM 116, etc.), capability data (e.g., which radio access technology(s) the SIM 116 is configured to use, etc.), authentication data, and/or the like.

As described above, in at least one example, the data management module 112 can comprise an interface that compares the device data 114 and the SIM data 118 to determine whether there is a mismatch in the device data 114 and the SIM data 118. In at least one example, based at least in part on detecting a mismatch between the device data 114 and the SIM data 118, the data management module 112 can generate a notification, which can be an indication, a suggestion, a recommendation, and/or the like to redress the mismatch. In some examples, the notification can include instructions to redress the mismatch by affecting a modification to the user equipment 102 and/or the SIM 116. In some examples, the instructions can be associated with an indication, a suggestion, a recommendation, and/or the like to modify, update, replace, or otherwise obtain a new user equipment that is configured to redress the mismatch, download or otherwise access software and/or a software update to redress the mismatch, and/or the like. In some examples, the instructions can be associated with an indication, a suggestion, a recommendation and/or the like to modify, update, replace, or otherwise obtain a new SIM that is configured to redress the mismatch, download or otherwise access software and/or a software update to redress the mismatch, and/or the like.

In some examples, the notification can trigger an action to be performed by the user equipment 102. For example, based at least in part on detecting that the user equipment 102 is missing functionality thereby causing a mismatch, the data management module 112 can send a request to the service provider to request to download software and/or a software update associated with the functionality and/or otherwise update the user equipment 102 to redress the mismatch. As another example, based at least in part on detecting that the SIM 116 is missing functionality thereby causing a mismatch, the data management module 112 can send a request to the service provider to request to download software and/or a software update associated with the functionality and/or otherwise update the SIM 116 to redress the mismatch.

In at least one example, based at least in part on comparing the device data 114 and the SIM data 118, the data management module 112 can determine that the user equipment 102 is not configured to use a particular radio access technology (e.g., 5G) and the SIM 116 is configured to use the particular radio access technology. Such a mismatch can affect the user experience of the user using the user equipment 102. In such an example, the data management module 112 can generate a notification that includes an indication, a suggestion, a recommendation, and/or the like to modify, update, or replace the user equipment 102 with a new user equipment that is configured to use the particular radio access technology, to download and/or otherwise obtain software and/or a software update to configure the user equipment 102 to use the particular radio access technology, and/or the like.

In at least one example, based at least in part on comparing the device data 114 and the SIM data 118, the data management module 112 can determine that the user equipment 102 is configured to use a particular radio access technology (e.g., 5G) and the SIM 116 is not configured to use the particular radio access technology. Such a mismatch can affect the user experience of the user using the user equipment 102. In such an example, the data management module 112 can generate a notification that includes an indication, a suggestion, a recommendation, and/or the like to modify, update, or replace the SIM 116 with a new SIM that is configured to use the particular radio access technology, to download and/or otherwise obtain software and/or a software update to configure the SIM 116 to use the particular radio access technology, and/or the like.

In at least one example, based at least in part on comparing the device data 114 and the SIM data 118, the data management module 112 can determine that the user equipment 102 is associated with a service provider and the SIM 116 is associated with a different service provider. Such a mismatch can affect the user experience of the user using the user equipment 102. In such an example, the data management module 112 can generate a notification that includes an indication, a suggestion, a recommendation, and/or the like to modify, update, or replace the user equipment 102 with a new user equipment that is associated with the different service provider. In an alternative example, the data management module 112 can generate a notification that includes an indication, a suggestion, a recommendation, and/or the like to modify, update, or replace the SIM 116 with a new SIM that is associated with the service provider, to download and/or otherwise obtain software and/or a software update to associate the SIM 116 with the service provider, and/or the like.

In at least one example, based at least in part on comparing the device data 114 and the SIM data 118, the data management module 112 can determine that the user equipment 102 is associated with a first brand of services offered by the service provider and the SIM 116 is associated with a second brand of services offered by the service provider. Such a mismatch can affect the user experience of the user using the user equipment 102. In such an example, the data management module 112 can generate a notification that includes an indication, a suggestion, a recommendation, and/or the like to modify, update, or replace the user equipment 102 with a new user equipment that is associated with the second brand. In an alternative example, the data management module 112 can generate a notification that includes an indication, a suggestion, a recommendation, and/or the like to modify, update, or replace the SIM 116 with a new SIM that is associated with the first brand, to download and/or otherwise obtain software and/or a software update to associate the SIM 116 with the service provider, and/or the like.

In some examples, the user equipment 102 can be a particular type of device, which can be associated with a classification. For example, the user equipment 102 can be associated with a mobile phone, an IoT device, an autonomous vehicle, a medical device, or the like. In such examples, SIMs with certain features can provide better user experiences than others for the particular type of device. That is, some SIM features can be preferable over other SIM features for the particular type of device. As an example, a SIM with more compute can provide a better user experience for an autonomous vehicle than a SIM with less compute. In at least one example, the data management module 112 can compare the device data 114, which can indicate the classification of the user equipment 102, with the SIM data 118, which can indicate that the SIM 116 is associated with a first feature. In at least one example, the data management module 112 can detect a mismatch based at least in part on determining that, based on the classification of the user equipment 102, the associated user experience can be optimized by the SIM 116 being associated with a second feature that is different than the first feature. In such an example, the data management module 112 can generate aa notification that can include an indication, a suggestion, a recommendation, and/or the like to modify, update, or replace the SIM 116 to be associated with the second feature, to download and/or otherwise obtain software and/or a software update to associate the SIM 116 with the second feature, and/or the like.

In some examples, the user equipment 102 can be executing an application. For example, a user of the user equipment 102 can be using a particular application on the user equipment 102. Such usage can be indicated in context data, which can be stored in the device data 114. In some examples, SIMs with certain features can provide better user experiences than others for the particular application. That is, some SIM features can be preferable over other SIM features for the particular application. For example, if an application is a healthcare application, a SIM with particular security feature(s) can provide an optimal user experience. In at least one example, the data management module 112 can compare the device data 114, which can indicate the application executing on the user equipment 102, with the SIM data 118, which can indicate that the SIM 116 is associated with a first feature. In at least one example, the data management module 112 can detect a mismatch based at least in part on determining that the user experience associated with the application can be optimized by the SIM 116 being associated with a second feature that is different than the first feature. In such an example, the data management module 112 can generate a notification that can include an indication, a suggestion, a recommendation, and/or the like to modify, update, or replace the SIM 116 to be associated with the second feature, to download and/or otherwise obtain software and/or a software update to associate the SIM 116 with the second feature, and/or the like.

In some examples, the user equipment 102 can be providing a service via an application, a web browser, and/or the like. For example, a user of the user equipment 102 can be using a particular service on the user equipment 102. Such usage can be indicated in context data, which can be stored in the device data 114. In some examples, SIMs with certain features can provide better user experiences than others for the particular service. That is, some SIM features can be preferable over other SIM features for the service. In at least one example, the data management module 112 can compare the device data 114, which can indicate the service, with the SIM data 118, which can indicate that the SIM 116 is associated with a first feature. In at least one example, the data management module 112 can detect a mismatch based at least in part on determining that the user experience associated with the service can be optimized by the SIM 116 being associated with a second feature that is different than the first feature. In such an example, the data management module 112 can generate a notification that can include an indication, a suggestion, a recommendation, and/or the like to modify, update, or replace the SIM 116 to be associated with the second feature, to download and/or otherwise obtain software and/or a software update to associate the SIM 116 with the second feature, and/or the like.

The examples provided above of identifying mismatches and generating notifications are examples and are not exhaustive. Techniques described herein can be used to identify any type of mismatch between the device data 114 and the SIM data 118 and can generate any type of notification to redress the mismatch to improve performance of the user equipment 102 and/or user experience.

In at least one example, the user equipment 102 can communicate with server(s) 120 associated with the service provider via one or more networks 122. In at least one example, the network(s) 122 can include access network(s) (e.g., network(s) that connect users (e.g., user equipment associated therewith) to a service provider (e.g., a telecommunications service provider)), provider network(s), a core network (which, in some examples can be a “carrier” network) (e.g., that connects one or more other service providers to one another), etc. In some examples, such network(s) 122 can comprise cellular networks, the Internet, and/or the like.

The server(s) 120 can include one or more components, such as processor(s) 124, computer-readable media 126, network hardware 128, and account(s) 130. The processor(s) 124 can comprise the same or similar structure and/or function as the processor(s) 104 described above. The computer-readable media 126, can include computer storage media and/or communication media, both of which are described above with reference to the computer-readable media 110. That is, the computer-readable media 126 can have the same or similar structure and/or function as the computer-readable media 110 described above.

The network hardware 128 can provide wired or wireless networking capabilities to the server(s) 120. The network hardware 128 can include or be incorporated into processors, ASICs, programmable circuits such as FPGAs, or in other ways.

The account(s) 130 can be stored locally with the server(s) 120 (as illustrated) and/or be stored remotely and be accessible to the server(s) 120. The account(s) 130 can store data associated with users (which can also be referred to as “subscribers” or “customers”), including but not limited to, data associated with user identities corresponding to account holders associated with user equipment, phone numbers of the account holders, address books of the account holders, contacts of the account holders, text messages sent and received via the user equipment, identity and/or service plan profiles (e.g., amount of data, voice calling, and/or text messaging available, whether data, voice calling, and/or text messaging is available internationally, data transmission speeds accessible, plan restrictions, etc.), etc. In at least one example, an account can additionally or alternatively include purchase history of the user account, a billing history associated with the user account, a subscription tier associated with the user account, services associated with the user account, a number of lines associated with the user account, or devices associated with the user account. In at least one example, a user account can enable a user to utilize wireless telecommunications services of the service provider, as described above. In some examples, the account(s) 130 can store device data 114 and/or SIM data 118, or a portion thereof, as described above.

The computer-readable media 126 can include one or more modules and data structures, such as a data management module 132. The data management module 132 can be in the form of stand-alone application, productivity application, an operating system component, or any other application or software module configured to perform operations as described herein. In at least one example, the data management module 132 can perform the same or similar operations as the data management module 112. That is, in at least one example, the data management module 132 can comprise the interface that accesses device data 114 and SIM data 118 to perform the comparison described herein. In some examples, the data management module 132, like the data management module 112 described above, can utilize machine learning and/or artificial intelligence in comparing the device data 114 and the SIM data 118 and/or generating notifications as described herein. That is, in some examples, the data management module 132 can utilize machine learning model(s) and/or artificial intelligence model(s) (e.g., supervised learning model(s), unsupervised learning model(s), semi-supervised learning model(s), and/or the like) to analyze the device data 114 and the SIM data 118 to identify mismatches and/or generate notifications as described herein. Use of such machine learning and/or artificial intelligence can enable the “intelligent” optimization of user experience, as described herein.

In some examples, at least a portion of the device data 114 and/or the SIM data 118 can be stored in the account(s) 130. In such examples, the data management module 132 can access the device data 114 and the SIM data 118 for comparison purposes as described herein. In some examples, however, the device data 114 and/or the SIM data 118 may not be stored in the account(s) 130 and/or some of the device data 114 and/or the SIM data 118 can be stored locally on the user equipment 102, as described above. In such examples, the data management module 132 can send a request to the user equipment 102 for the device data 114 and/or the SIM data 118. The data management module 132 can receive the device data 114 and/or the SIM data 118 from the user equipment 102 and can perform the comparison as described above with reference to the data management module 112. That is, in some examples, the data management module 132 can fetch the device data 114 and/or the SIM data 118 from the user equipment 102.

In at least one example, based at least in part on detecting a mismatch between the device data 114 and the SIM data 118, the data management module 132 can generate a notification and send the notification to the user equipment 102. In such an example, the notification can be sent as a text message, email, push notification, or the like. Based at least in part on receiving the notification, the user equipment 102 can cause the notification to be presented via a display of the user equipment 102 (e.g., via an input/output device 108). Examples of mismatches and/or notifications are provided above.

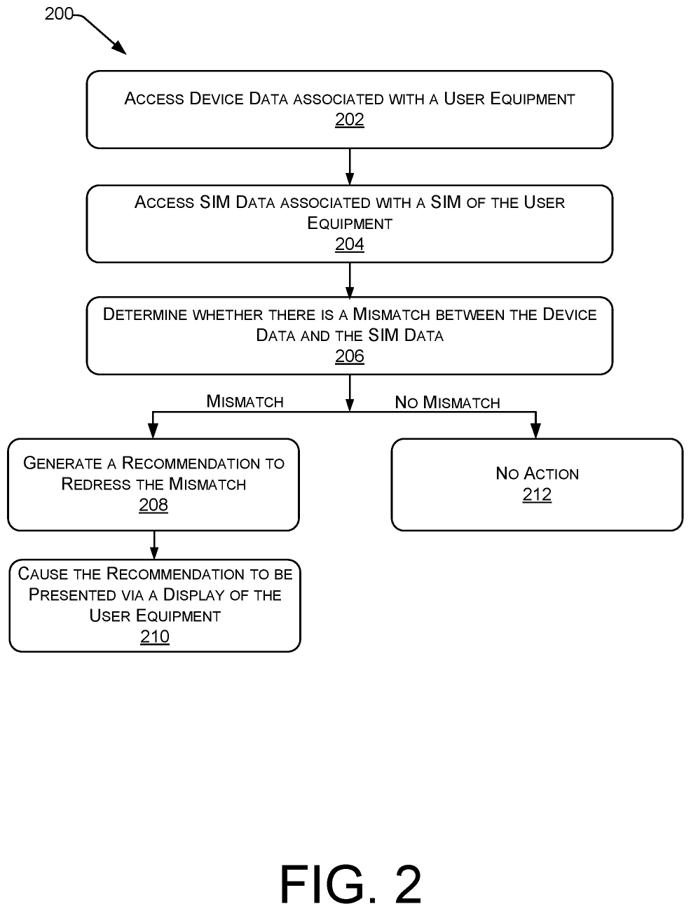

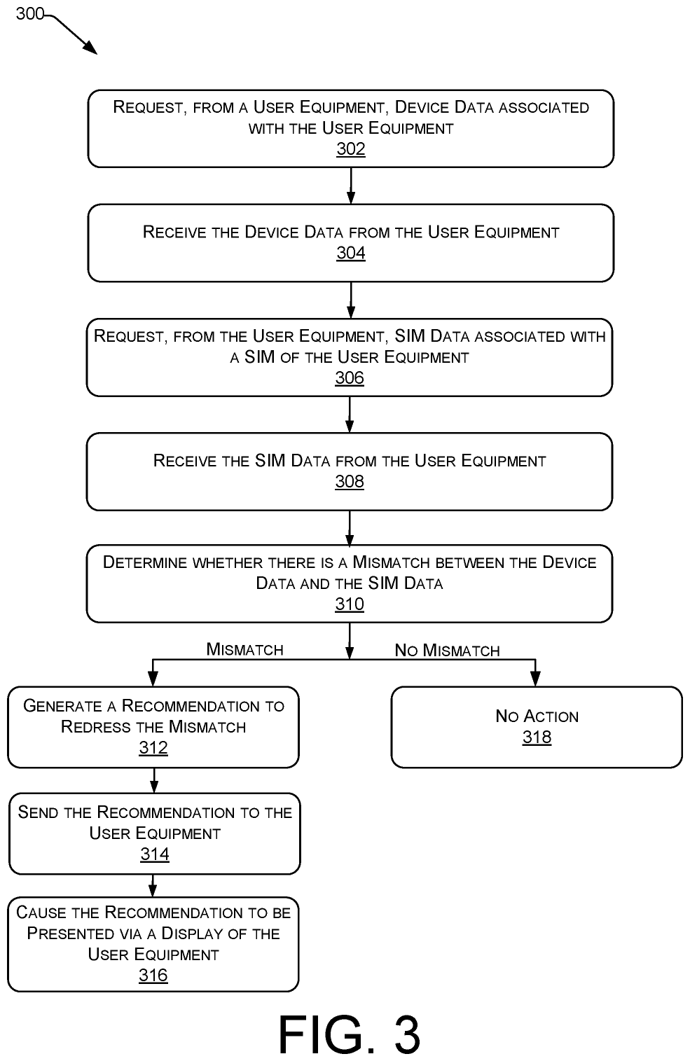

FIGS. 2 and 3 illustrate example processes in accordance with embodiments of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted and/or combined in any order and/or in parallel to implement the processes.

FIGS. 2 and 3 are described with reference to components of the example environment described above with reference to FIG. 1. However, FIGS. 2 and 3 are not limited to such an environment and the components described above with reference to FIG. 1 are not limited to performing the operations described below with reference to FIGS. 2 and 3.

FIG. 2 illustrates an example process 200 for generating a notification based at least in part on an identified mismatch in device data and subscriber identity module (SIM) data, as described herein.

At operation 202, the data management module 112 can access device data associated with a user equipment. As described above, in at least one example, device data 114 can be stored on the user equipment 102, for example in a database or other data store. The device data 114 can include, but is not limited to, identification data (e.g., device identifier, etc.), user account data (e.g., name, account number, etc.), service provider data (e.g., current service provider, available service providers, service(s) available via the service provider, etc.), brand data (e.g., current brand associated with the user equipment 102, etc.), context data (e.g., which application(s) are executing on the user equipment 102), capability data (e.g., which radio access technology(s) the user equipment 102 is configured to use, etc.), and/or the like. In some examples, the device data 114 can indicate device features, including, but not limited to, radio technology (e.g., NR, LTE, UMTS, CDMA, GSM), a frequency band, voice protocol (e.g., voice on UMTS, CDMA, GSM, etc.), messaging (e.g., SMS), a speed feature (e.g., carrier aggregation (CA), 4×4 multiple input and multiple output (MIMO), or 256QAM modulation in downlink, etc.), regulatory data (e.g., E911 location, wireless emergency alerts (WEA), etc.), dual SIM lock data, dual device unlock data, IP multimedia subsystem (IMS) services (e.g., voice over LTE (VoLTE), wi-fi calling (WFC), rich communication services (RCS), etc.), mobile hotspot data, accessibility data (e.g., text telephone (TTY), real time text (RTT), etc.), a service provider service (e.g., visual voicemail, account management, name/identification, etc.), a third-party application, a setting (e.g., access point name (APN), browser default, ringtone, splash screen, etc.), a background (e.g., identification applications, analytics applications, etc.), etc. In at least one example, the data management module 112 can access the device data 114.

At operation 204, the data management module 112 can access SIM data associated with a SIM of the user equipment. As described above, in at least one example, the SIM 116 can store SIM data 118. The SIM data 118 can include personal data of a user, such as, but not limited to, data associated with a phone number of a user associated with the user equipment 102, an address book of the user, text messages sent and received via the user equipment 102, and other data. In at least one example, the SIM data 118 can be associated with profile(s) that can be stored on the SIM 116 or can otherwise be accessible by the SIM 116. In at least one example, a profile can indicate which service plans, services, functionalities, etc. are available for the user equipment 102 from a particular service provider. In some examples, the SIM data 118 can include service provider data (e.g., current service provider associated with the SIM 116, etc.), brand data (e.g., current brand associated with the SIM 116, etc.), capability data (e.g., which radio access technology(s) the SIM 116 is configured to use, etc.), and/or the like. service provider data, brand data, capability data (e.g., which radio access technology(s) the SIM 116 is configured to use, etc.), security data, authentication data, and/or the like. In at least one example, the data management module 112 can access SIM data 118 associated with the SIM 116 of the user equipment 102.

At operation 206, the data management module 112 can determine whether there is a mismatch between the device data and the SIM data. As described above, in at least one example, the data management module 112 can comprise an interface that compares the device data 114 and the SIM data 118 to determine whether there is a mismatch in the device data 114 and the SIM data 118. That is, the data management module 112 can compare the device data 114 with the SIM data 118 to determine similarities and/or differences between the device data 114 and the SIM data 118. In some examples, the data management module 112 can utilize machine learning and/or artificial intelligence in comparing the device data 114 and the SIM data 118 and/or generating notifications as described herein. That is, in some examples, the data management module 112 can utilize machine learning model(s) and/or artificial intelligence model(s) (e.g., supervised learning model(s), unsupervised learning model(s), semi-supervised learning model(s), and/or the like) to analyze the device data 114 and the SIM data 118 to identify mismatches and/or generate notifications as described herein. Use of such machine learning and/or artificial intelligence can enable the “intelligent” optimization of user experience, as described herein.

At operation 208, based at least in part on detecting a mismatch, the data management module 112 can generate a notification to redress the mismatch. In at least one example, based at least in part on detecting a mismatch between the device data 114 and the SIM data 118, the data management module 112 can generate a notification to affect a modification to the user equipment 102 and/or the SIM 116 to redress the mismatch. As described above, the mismatch can limit the functionality and/or capabilities of the user equipment 102, affecting the performance of the user equipment 102 and/or the user experience of the user using the user equipment 102. As such, to provide an optimal user experience, the data management module 112 can generate a notification to redress the mismatch.

In some examples, the notification can include instructions to redress the mismatch via the user equipment 102. In some examples, the instructions can be associated with an indication, a suggestion, a recommendation and/or the like to modify, update, replace, or otherwise obtain a new user equipment that is configured to redress the mismatch, download or otherwise access software and/or a software update to redress the mismatch, and/or the like. In some examples, the notification can include instructions to redress the mismatch via the SIM 116. In some examples, the instructions can be associated with an indication, a suggestion, a recommendation, and/or the like to modify, update, replace, or otherwise obtain a new SIM that is configured to redress the mismatch, download or otherwise access software and/or a software update to redress the mismatch, and/or the like. Examples of mismatches and/or notifications are provided above.

At operation 210, the data management module 112 can cause the notification to be presented via a display of the user equipment. In at least one example, the data management module 112 can cause the notification to be presented via a display of the user equipment 102. In some examples, the notification can be presented as a system message. In some examples, the notification can be presented as a pop-up, overlay, or other user interface element. In some examples, the notification can be associated with an additional or alternative message (e.g., a text message, an email, a push notification, or the like).

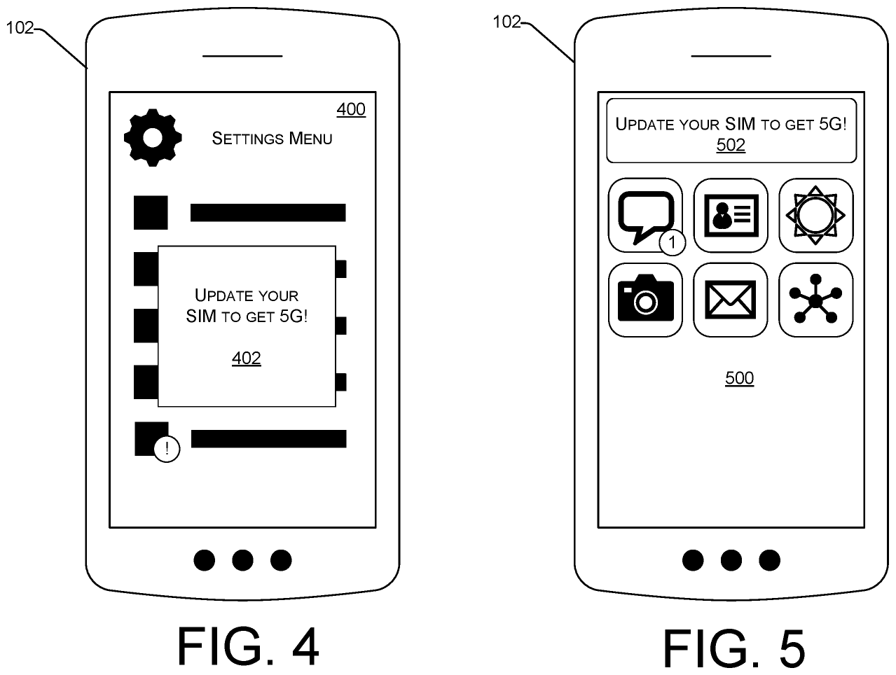

FIG. 4 illustrates an example graphical user interface 400 in which a notification can be presented. In at least one example, the data management module 112 can present the notification via a system message, as shown in FIG. 4. That is, in at least one example, the notification can be associated with an indication that there is a new system message and, based at least in part on interacting with the indication, the notification 402 can be presented via the graphical user interface 400. In some examples, the notification 402 can be presented without having first been associated with an indication and/or interaction. That is, in some examples, the notification 402 can be presented as a pop-up, overlay, or other user interface element. In some examples, the notification 402 can include one or more mechanisms to enable the user to perform the suggestion associated with the notification 402 (e.g., replace the user equipment 102, update the SIM 116, download software and/or a software update, etc.). For example, such one or more mechanisms may comprise a hyperlink or other actuation mechanism that, when actuated, opens to an application, a webpage, or other resource to enable the user to affect a modification to the user equipment 102 and/or the SIM 116.

At operation 212, if a mismatch is not detected, the data management module 112 can refrain from performing any action. In some examples, if no mismatch is detected, the user equipment 102 and/or the SIM 116 can be interoperable in their current states. That is, the user equipment 102 can be configured for use with the currently installed and/or active SIM 116 and vice versa.

FIG. 3 illustrates another example process 300 for generating a notification based at least in part on an identified mismatch in device data and SIM data, as described herein.

At operation 302, the data management module 132 can request, from a user equipment, device data associated with the user equipment. As described above, in at least one example, device data 114 can be stored on the user equipment 102, for example in a database or other data store. The device data 114 can include, but is not limited to, identification data (e.g., device identifier, etc.), user account data (e.g., name, account number, etc.), service provider data (e.g., current service provider, available service providers, service(s) available via the service provider, etc.), brand data (e.g., current brand associated with the user equipment 102, etc.), context data (e.g., which application(s) are executing on the user equipment 102), capability data (e.g., which radio access technology(s) the user equipment 102 is configured to use, etc.), and/or the like. In some examples, the device data 114 can indicate device features, including, but not limited to, radio technology (e.g., NR, LTE, UMTS, CDMA, GSM), a frequency band, voice protocol (e.g., voice on UMTS, CDMA, GSM, etc.), messaging (e.g., SMS), a speed feature (e.g., carrier aggregation (CA), 4×4 multiple input and multiple output (MIMO), or 256QAM modulation in downlink, etc.), regulatory data (e.g., E911 location, wireless emergency alerts (WEA), etc.), dual SIM lock data, dual device unlock data, IP multimedia subsystem (IMS) services (e.g., voice over LTE (VoLTE), wi-fi calling (WFC), rich communication services (RCS), etc.), mobile hotspot data, accessibility data (e.g., text telephone (TTY), real time text (RTT), etc.), a service provider service (e.g., visual voicemail, account management, name/identification, etc.), a third-party application, a setting (e.g., access point name (APN), browser default, ringtone, splash screen, etc.), a background (e.g., identification applications, analytics applications, etc.), etc. In at least one example, the data management module 132 can send a request to the user equipment 102 for the device data 114. Based at least in part on sending the request, the data management module 132 can receive the device data 114 from the user equipment 102, as illustrated at operation 304.

At operation 306, the data management module 132 can request, from the user equipment, SIM data associated with a SIM of the user equipment. As described above, in at least one example, the SIM 116 can store SIM data 118. The SIM data 118 can include personal data of a user, such as, but not limited to, data associated with a phone number of a user associated with the user equipment 102, an address book of the user, text messages sent and received via the user equipment 102, and other data. In at least one example, the SIM data 118 can be associated with profile(s) that can be stored on the SIM 116 or can otherwise be accessible by the SIM 116. In at least one example, a profile can indicate which service plans, services, functionalities, etc. are available for the user equipment 102 from a particular service provider. In some examples, the SIM data 118 can include service provider data (e.g., current service provider associated with the SIM 116, etc.), brand data (e.g., current brand associated with the SIM 116, etc.), capability data (e.g., which radio access technology(s) the SIM 116 is configured to use, etc.), and/or the like. service provider data, brand data, capability data (e.g., which radio access technology(s) the SIM 116 is configured to use, etc.), security data, authentication data, and/or the like. In at least one example, the data management module 132 can send a request to the user equipment 102 for SIM data 118 associated with the SIM 116 of the user equipment 102. Based at least in part on sending the request, the data management module 132 can receive the SIM data 118 from the user equipment 102, as illustrated at operation 308.

While operations 302 and 306 are shown as separate operations and operations 304 and 308 are shown as separate operations, in some examples, a single request can be sent to the user equipment 102, requesting device data 114 and SIM data 118, and a single response can be received by the data management module 132, including both device data 114 and SIM data 118.

At operation 310, the data management module 132 can determine whether there is a mismatch between the device data and the SIM data. As described above, in at least one example, the data management module 132 can comprise an interface that compares the device data 114 and the SIM data 118 to determine whether there is a mismatch in the device data 114 and the SIM data 118. That is, the data management module 132 can compare the device data 114 with the SIM data 118 to determine similarities and/or differences between the device data 114 and the SIM data 118. In some examples, the data management module 132 can utilize machine learning and/or artificial intelligence in comparing the device data 114 and the SIM data 118 and/or generating notifications as described herein. That is, in some examples, the data management module 132 can utilize machine learning model(s) and/or artificial intelligence model(s) (e.g., supervised learning model(s), unsupervised learning model(s), semi-supervised learning model(s), and/or the like) to analyze the device data 114 and the SIM data 118 to identify mismatches and/or generate notifications as described herein. Use of such machine learning and/or artificial intelligence can enable the “intelligent” optimization of user experience, as described herein.

At operation 312, based at least in part on detecting a mismatch, the data management module 132 can generate a notification to redress the mismatch. As described above, in at least one example, based at least in part on detecting a mismatch between the device data 114 and the SIM data 118, the data management module 132 can generate a notification to affect a modification to the user equipment 102 and/or the SIM 116 to redress the mismatch. As described above, the mismatch can limit the functionality and/or capabilities of the user equipment 102, affecting the performance of the user equipment 102 and/or the user experience of the user using the user equipment 102. As such, to provide an optimal user experience, the data management module 112 can generate a notification to redress the mismatch.

In some examples, the notification can include instructions to redress the mismatch via the user equipment 102. In some examples, the instructions can be associated with an indication, a suggestion, a recommendation, and/or the like to modify, update, replace, or otherwise obtain a new user equipment that is configured to redress the mismatch, download or otherwise access software and/or a software update to redress the mismatch, and/or the like. In some examples, the notification can include instructions to redress the mismatch via the SIM 116. In some examples, the instructions can be associated with an indication, a suggestion, a recommendation, and/or the like to modify, update, replace, or otherwise obtain a new SIM that is configured to redress the mismatch, download or otherwise access software and/or a software update to redress the mismatch, and/or the like. Examples of mismatches and/or notifications are provided above.

At operation 314, the data management module 132 can send the notification to the user equipment. In at least one example, the data management module 132 can send the notification to the user equipment 102, for example, as a text massage, email, push notification, or the like.

At operation 316, the data management module 132 can cause the notification to be presented via a display of the user equipment. In at least one example, the data management module 112 can receive the notification from the data management module 132 and can present the notification via a display of the user equipment 102. In some examples, an application can receive the notification and present the notification via the display of the user equipment 102. That is, the data management module 132 can cause the notification to be presented via the display of the user equipment 102.

FIG. 5 illustrates an example graphical user interface 500 in which a notification can be presented. In at least one example, the data management module 132 can send the notification to the user equipment as a text message, email, push notification, or the like. In at least one example, based at least in part on receiving the notification, an indication that a new message (e.g., the notification) has been received can be presented in association with a particular application. In some examples, based at least in part on detecting an interaction with the indication, the application can present the notification 502 via the graphical user interface 500 as a new text message (or other applicable format). In some examples, the notification 502 can include one or more mechanisms to enable the user to perform the suggestion associated with the notification 502 (e.g., replace the user equipment 102, update the SIM 116, download software and/or a software update, etc.). For example, such one or more mechanisms may comprise a hyperlink or other actuation mechanism that, when actuated, opens to an application, a webpage, or other resource to enable the user to affect a modification to the user equipment 102 and/or the SIM 116.

At operation 318, if a mismatch is not detected, the data management module 132 can refrain from performing any action.

FIG. 2 illustrates an example process 200 for generating a notification based at least in part on an identified mismatch in device data 114 and SIM data 118, wherein the comparison between device data 114 and the SIM data 118 is performed by the data management module 112 on the user equipment 102. FIG. 3 illustrates another example process 300 for generating a notification based at least in part on an identified mismatch in device data 114 and SIM data 118, wherein the comparison between device data 114 and the SIM data 118 is performed by the data management module 132 on the server(s) 120. In at least one example, performing the comparison on the server(s) 120 can provide one or more computational benefits in that the user equipment 102 can be limited in processing power and/or the frequency in which updates can be made. In some examples, the comparison described above can be performed in a distributed manner, wherein the data management module 112 performs a portion thereof and the data management module 132 performs a portion thereof.

FIGS. 4 and 5 illustrate example graphical user interfaces in which a notification can be presented. The graphical user interfaces 400 and 500 are non-limiting examples of how notifications can be presented. In some examples, notifications can be presented via additional or alternative outputs (e.g., haptically, audibly, etc.). In some examples, the notifications can include additional or alternative data that can be arranged in additional or alternative configurations. In some examples, the notifications can be interactable to enable the user to perform an action.

Although the subject matter has been described in language specific to structural data items and/or methodological acts, it is to be understood that the subject matter defined in the appended claims is not necessarily limited to the specific data items or acts described. Rather, the specific data items and acts are disclosed as example forms of implementing the claims.

1. A method comprising:
accessing device data associated with a user equipment;
accessing subscriber identity module (SIM) data associated with a SIM of the user equipment;
comparing the device data and the SIM data;
determining, based at least in part on the comparing, a mismatch between the device data and the SIM data;
based at least in part on determining the mismatch, generating a notification, wherein the notification includes an instruction to redress the mismatch; and
causing the notification to be presented via a display of the user equipment,
wherein the device data indicates that the user equipment is configured with Fifth Generation (5G) capability and the SIM data indicates that the SIM is not configured with 5G capability, and wherein the instruction comprises a suggestion to replace the SIM with a new SIM having 5G capability.

2. The method as claim 1 recites, wherein the device data indicates that the user equipment is configured with Fifth Generation (5G) capability and the SIM data indicates that the SIM is not configured with 5G capability, and wherein the instruction comprises a further suggestion to download software or a software update to configure the SIM with 5G capability.

3. (canceled)

4. The method as claim 1 recites, wherein the device data indicates that the user equipment is associated with a first brand of a service provider and the SIM data indicates that the SIM is associated with a second brand of the service provider, and wherein the instruction comprises a further suggestion to (i) replace the SIM with a new SIM associated with the first brand or (ii) download software or a software update to associate the SIM with the first brand.

5. The method as claim 1 recites, wherein the device data indicates that the user equipment is associated with a first brand of a service provider and the SIM data indicates that the SIM is associated with a second brand of the service provider, and wherein the instruction comprises a further suggestion to replace the user equipment with a different user equipment associated with the second brand.

6. The method as claim 1 recites, wherein the device data indicates that the user equipment is associated with a first service provider and the SIM data indicates that the SIM is associated with a second service provider, and wherein the instruction comprises a further suggestion to (i) replace the SIM with a new SIM associated with the first service provider or (ii) download software or a software update to associate the SIM with the first service provider.

7. The method as claim 1 recites, wherein the device data indicates that the user equipment is associated with a first service provider and the SIM data indicates that the SIM is associated with a second service provider, and wherein the instruction comprises a further suggestion to replace the user equipment with a different user equipment associated with the second service provider.

8. A system comprising:
one or more processors; and
one or more non-transitory computer-readable media storing instructions that, when executed by the one or more processors, cause the system to perform operations comprising:
accessing device data associated with a user equipment;
accessing subscriber identity module (SIM) data associated with a SIM of the user equipment;
comparing the device data and the SIM data;
generating, based at least in part on the comparing, a notification that includes an instruction to affect a modification to the user equipment or the SIM; and
causing the notification to be presented via a display of the user equipment,
wherein the device data indicates that the user equipment is not configured with Fifth Generation (5G) capability and the SIM data indicates that the SIM is configured with 5G capability, and wherein the instruction comprises a suggestion to replace the user equipment with a new user equipment configured with 5G capability.

9. The system as claim 8 recites, wherein the device data indicates that the user equipment is associated with a first radio access technology and the SIM data indicates that the SIM is associated with a second radio access technology, and wherein the instruction comprises (i) a first suggestion to replace the user equipment with a different user equipment associated with the second radio access technology or (ii) a second suggestion to replace the SIM with a different SIM associated with the first radio access technology.

10. The system as claim 8 recites, wherein the device data indicates that the user equipment is associated with a first service provider and the SIM data indicates that the SIM is associated with a second service provider, and wherein the instruction comprises (i) a first suggestion to replace the user equipment with a different user equipment associated with the second service provider or (ii) a second suggestion to replace the SIM with a different SIM associated with the first service provider.

11. The system as claim 8 recites, wherein the device data indicates that the user equipment is associated with a first brand and the SIM data indicates that the SIM is associated with a second brand, and wherein the instruction comprises (i) a first suggestion to replace the user equipment with a different user equipment associated with the second brand or (ii) a second suggestion to replace the SIM with a different SIM associated with the first brand.

12. The system as claim 8 recites, wherein the device data indicates a classification of the user equipment and the SIM data indicates that the SIM is associated with a first feature, the operations further comprising:
determining, based at least in part on the classification, that a second feature is preferable over the first feature, and wherein the instruction comprises a suggestion to (i) replace the SIM with a different SIM associated with the second feature or (ii) download software or a software update associated with the second feature.

13. The system as claim 8 recites, wherein the device data indicates that the user equipment is associated with an application and the SIM data indicates that the SIM is associated with a first feature, the operations further comprising:
determining, based at least in part on the application, that a second feature is preferable over the first feature, and wherein the instruction comprises a suggestion to (i) replace the SIM with a different SIM associated with the second feature or (ii) download software or a software update associated with the second feature.

14. The system as claim 8 recites, wherein the system is the user equipment and the notification is presented as a system notification.

15. The system as claim 8 recites, wherein the system is remotely located from the user equipment and the notification is presented as a text message, email, or push notification.

16. One or more non-transitory computer-readable media storing instructions that, when executed by one or more processors, cause the one or more processors to perform operations comprising:
accessing device data associated with a user equipment;
accessing subscriber identity module (SIM) data associated with a SIM of the user equipment;
comparing the device data and the SIM data;
generating a notification based at least in part on the comparing, wherein the notification includes an instruction to affect a modification to the user equipment or the SIM; and
causing the notification to be presented via a display of the user equipment,
wherein the device data indicates that the user equipment is configured with Fifth Generation (5G) capability and the SIM data indicates that the SIM is not configured with 5G capability, and wherein the instruction comprises a suggestion to replace the SIM with a new SIM having 5G capability.

17. The one or more non-transitory computer-readable media as claim 16 recites, wherein the device data indicates that the user equipment is associated with a first radio access technology and the SIM data indicates that the SIM is associated with a second radio access technology, and wherein the instruction comprises (i) a first suggestion to affect the modification to the user equipment or (ii) a second suggestion to affect the modification to the SIM.

18. The one or more non-transitory computer-readable media as claim 16 recites, wherein the device data indicates that the user equipment is associated with at least one of a first brand or a first service provider and the SIM data indicates that the SIM is associated with at least one of a second brand or a second service provider, and wherein the instruction comprises (i) a first suggestion to affect the modification to the user equipment or (ii) a second suggestion to affect the modification to the SIM.

19. The one or more non-transitory computer-readable media as claim 16 recites, wherein the device data indicates a classification of the user equipment and the SIM data indicates that the SIM is associated with a first feature, the operations further comprising:
determining, based at least in part on the classification, that a second feature is preferable over the first feature, and wherein the instruction comprises a suggestion to affect the modification to the SIM, wherein the SIM or a new SIM is associated with the second feature.

20. The one or more non-transitory computer-readable media as claim 16 recites, wherein the device data indicates that the user equipment is associated with an application and the SIM data indicates that the SIM is associated with a first feature, the operations further comprising:
determining, based at least in part on the application, that a second feature is preferable over the first feature, and wherein the data comprises a suggestion to affect the modification to the SIM, wherein the SIM or a new SIM is associated with the second feature.
